(19) United States
(12) Patent Application Publication
(10) Pub. No.: US 2022/0142849 A1
(43) Pub. Date: May 12, 2022

(54) APPARATUS FOR REHABILITATION OF ADHESIVE CAPSULITIS AND METHOD FOR CONTROLLING THE SAME

(71) Applicant: Jong hoon Kwon, Pyeongtaek-si (KR)

(72) Inventor: Jong hoon Kwon, Pyeongtaek-si (KR)

(21) Appl. No.: 17/520,670

(22) Filed: Nov. 7, 2021

(30) Foreign Application Priority Data
Nov. 6, 2020 (KR) 10-2020-0147931

(51) Int. Cl. A61H 1/02; A61H 23/00

(52) U.S. Cl. CPC A61H 1/0281; A61H 23/00; A61H 2201/1676; A61H 2201/1635; A61H 2201/0207; A61H 2201/5069

(57) ABSTRACT

Provided is an apparatus for rehabilitation. The apparatus for rehabilitation includes a body, a support that is rotatably provided on one surface of a body, a fixing part that is provided on one surface of the support to fix a user's arm, a first motor that rotates the support in a first direction by using a first axis as a rotation axis to assist abduction of the user, and a second motor that rotates the support in a second direction by using a second axis as a rotation axis to assist extention of the user.

### CROSS-REFERENCE TO RELATED APPLICATIONS

This U.S. non-provisional patent application claims priority under 35 U.S.C. § 119 of Korean Patent Application No. 10-2020-0147931, filed on Nov. 6, 2021, the entire contents of which are hereby incorporated by reference.

### BACKGROUND

The present invention relates to an apparatus for assisting rehabilitation of frozen shoulder or adhesive capsulitis and a method for controlling the same.

Adhesive capsulitis of shoulder is also called frozen shoulders, and in the medical fields, is called adhesive capsulitis. It is a symptom that occurs mainly in people in their 40s and 60s, and it is said to appear in 2% to 5% of the total population, and is known to be more frequent in women. As symptoms of the adhesive capsulitis, while the tissue of the shoulder joint becomes thicker or harder than normal, as times elapses, scar tissue occurs in the shoulder joint, and the range of motion is limited as there is not enough space for the shoulder joint to rotate.

The prognosis of the symptoms of the adhesive capsulitis varies greatly from person to person, and the adhesive capsulitis is known to be usually lasts for about 6 months to about 24 months and then heal spontaneously. However, in some cases, even after a sufficient period of time elapse, severe pain occurs, or the limitation of the range of motion persists permanently. Therefore, early diagnosis and active treatment are required.

The basic principle of the treatment of the adhesive capsulitis is to use conservative therapy without surgery, and the most important treatment is to restore the range of the joint motion through the active and/or passive joint motion. It is the orthodoxy of the medical community that continuous and active exercise treatment is the best treatment method. As the treatment and/or rehabilitation therapy, it is common to perform stretching so as to prevent atrophy of the joint capsule and strength exercise for strengthening the muscles around the shoulder. However, in the references coming currently on the market or being introduced, apparatuses or methods for strengthening the muscles in a state in which the shoulder and elbow joints are flexed using elastic bands or towels. On the other hand, products focused on enhancing accurate abduction and/or extention movements are not widely used.

### SUMMARY

The present invention relates to an apparatus for rehabilitation for assisting an effective exercise method in rehabilitation of adhesive capsulitis and a method for controlling the same. Specifically, in the rehabilitation in which a user stretches muscle by repeating extention and abduction, the apparatus may assist moving of an arm up to a limit value in motion range of a user's shoulder.

Embodiments of the present invention provide an apparatus for rehabilitation, including: a body; a support that is rotatably provided on one surface of a body; a fixing part that is provided on one surface of the support to fix a user's arm; a first motor that rotates the support in a first direction by using a first axis as a rotation axis to assist abduction of the user; and a second motor that rotates the support in a second direction by using a second axis as a rotation axis to assist extention of the user. In some embodiments, the apparatus for rehabilitation may include a detection part that detects at least one or more of a first angle, at which the first motor is rotated from a basic state, a second angle, at which the second motor is rotated from the basic state, rotation resistance of the first motor, and rotation resistance of the second motor; and a control part that controls the first motor and the second motor in response to a value detected by the detection part.

In some embodiments, when the rotation resistance of the first motor is equal to or greater than a first resistance value, the control part may control the first motor to stop the rotation for the abduction assistance, and when the rotation resistance of the second motor is equal to or greater than a second resistance value, the control part may control the second motor to stop the rotation for the extention assistance.

In some embodiments, when the first angle is equal to or greater than a first limit angle, the control part may control the first motor to stop the rotation for the abduction assistance, and when the second angle is equal to or greater than a second limit angle, the control part may control the second motor to stop the rotation for the extention assistance.

In some embodiments, the apparatus may further include: a handle that is held by the user in a state in which the arm is fixed; and a connection member that connects the handle to one end of the support.

In some embodiments, the connection member may include a rail or a spring, and a distance between the handle and one end of the support may be adjustable.

In some embodiments, the fixing part may further include a vibration pad that surrounds the user's arm.

In some embodiments, the fixing part may further include a heating pad that surrounds the user's arm.

In some embodiments, the fixing part may further include a low-frequency pad that surrounds the user's arm.

In embodiments of the present invention, a method for controlling an apparatus for rehabilitation may be used in a state in which a user's arm is fixed to a support. In some embodiments, the method may include: a first process of assisting abduction of a user while increasing in a first angle at which a first motor having a first axis as a rotation axis is rotated; a second process of stopping the assistance of the abduction of the user when a measured value with respect to the first motor is greater than or equal to a first reference value; a third process of assisting extension of the user while increasing a second angle at which a second motor having a second axis as a rotation axis is rotated; and a fourth process of stopping the assistance of the extention of the user when a measured value with respect to the second motor is greater than or equal to a second reference value.

In some embodiments, the first reference value may be a first resistance value that is rotation resistance of the first motor, and the second reference value may be a second resistance value that is rotation resistance of the second motor.

In some embodiments, the first reference value may be a first limit angle that is a value to which the first angle increases maximally, and the second reference value may be a second limit angle that is a value to which the second angle increases maximally.

In some embodiments, the method may further include, after the fourth process, a fifth process of assisting the user so that the second motor becomes a second basic state; and a sixth process of assisting the user so that the first motor becomes a first basic state.

In some embodiments, in the first basic state, the first angle may have a value less than or equal to a first default value, and in the second basic state, the second angle may have a value less than or equal to a second default value.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1A is perspective, FIG. 1B is cross-sectional, and FIG. 1C is plain views illustrating a structure of an apparatus for rehabilitation according to embodiments of the present invention;

FIGS. 2A, 2B, 2C and 2D are a view illustrating a state in which the apparatus for rehabilitation assists abduction of a user according to embodiments of the present invention;

FIGS. 3A, 3B, 3C and 3D are a view illustrating a state in which the apparatus for rehabilitation assists extention of a user according to embodiments of the present invention;

FIGS. 4A and 4B are drawings illustrating a state in which the apparatus for rehabilitation assists the abduction and the extention of the user based on rotation resistance of a motor according to embodiments of the present invention;

FIGS. 5A and 5B are drawings illustrating a state in which the apparatus for rehabilitation assists the abduction and the extention of the user based on a rotation angle of the motor according to embodiments of the present invention;

FIG. 6 is a view illustrating a state in which the apparatus for rehabilitation assists the abduction and the extention of the user based on the rotation resistance and the rotation angle of the motor according to embodiments of the present invention;

FIG. 7 is a view illustrating a state in which the apparatus for rehabilitation assists the extention of the abduction and the extention of the user based on the rotation resistance and the rotation angle of the motor according to embodiments of the present invention; and

FIGS. 8A and 8B are drawings illustrating a state in which the apparatus for rehabilitation assists the abduction of the user based on the rotation resistance and the rotation angle of the motor according to embodiments of the present invention.

### DETAILED DESCRIPTION

Hereinafter, preferred embodiments of the present invention will be described with reference to the accompanying drawings so that the object of the present invention is specifically understood and realized.

In this process, the size or shape of the components shown in the drawings may be exaggerated for clarity and convenience of explanation. In addition, terms specifically defined in consideration of the configuration and operation of the present invention may vary depending on the intentions or customs of users and operators.

In the present invention, terms such as ‘first’, ‘and/or’ ‘second’ may be used to describe various components, but the components are not limited to the above terms. The above terms are only used for the purpose of distinguishing one component from other components. For example, the first component may be named as the second component, similarly, the second component may also be named as the first component without departing from the scope of the appended claims according to the concept of the present invention.

These terms should be defined and understood based on the content throughout this specification.

Hereinafter, an apparatus for rehabilitation of a frozen shoulder and a method for controlling the same according to embodiments of the present invention will be described in detail.

Adhesive capsulitis is a movement disease that limits a range of motion of the shoulder joint. In other words, the adhesive capsulitis is called a frozen shoulder. Medically, the expression that is the adhesive capsulitis is used. This symptom is characterized in that, as the tissue surrounding the outer side of the shoulder joint becomes inflamed, the range of motion of the shoulder decreases, and the pain is caused.

The adhesive capsulitis usually heals spontaneously within about 1 years to about 3 years after the onset of the adhesive capsulitis. The cause of disease is diverse, and no single established cause has been found. There are primary causes and secondary causes of the adhesive capsulitis.

The adhesive capsulitis according to the primary cause is a case in which the disease occurs without a specific cause. This is a case in which the range of motion of the patient's shoulder decreased, but no specific cause is found. The adhesive capsulitis due to the secondary causes is a case in which a problem occurs in the rotator cuff or tissue calcification depending on the shoulder joint or systemic cause. This corresponds to a case in which the patient is unable to use the shoulder due to the pain and stiffens when the patient moves the shoulder. Also, if the user has the diabetes or thyroid disease, the adhesive capsulitis is more likely to develop.

The orthodoxy of the medical community is that continuous and active stretching and exercise are the best treatment methods for the adhesive capsulitis. Accordingly, the adhesive capsulitis patient needs to release the stiff shoulder joint by repeating steady stretching. In the adhesive capsulitis patients, movement of the shoulder becomes inconvenient due to fibrosis of the articular capsule of the shoulder. Therefore, for the adhesive capsulitis patients, both the ‘active movement’ that moves the shoulder area by the patient's own will and the ‘passive movement’ that moves the shoulder area passively with the help of another person or device are limited.

The present invention provides an apparatus 1 for rehabilitation for assisting the rehabilitation exercise of the adhesive capsulitis patient of which motion activity is limited and a method for controlling the same. The apparatus 1 for rehabilitation according to embodiments may assist the rotation of the shoulder and arm by using a motor while fixing the arm of the adhesive capsulitis patients to a fixing part 30. In addition, it helps the user's active rotation of the arm to the extent that active movement is possible, and then, in a rotation region in which only passive movement is possible, manual movement may be aided up to a set range of motion and/or within a range that does not put strain on the patient's arms and shoulders.

The exercise and stretching process may be divided into two processes. The first process is an abduction process, in which the user's arm is spread out to the side in the attentive posture, and the arm moves away from a central axis of the body. The range of motion for abduction of normal persons is between 0 degrees and about 180 degrees, but in the case of the adhesive capsulitis patient, it may be desirable to assist the stretching so that the arm abducts about 120 degrees from the attentive posture. The second process is an extention process, in which the arm raised in the abduction process is extended behind the body. The range of motion for extention of normal persons is between 0 degrees and about 50 degrees, but in the case of the adhesive capsulitis patient, it may be desirable to assist the stretching so that the arm extends about 20 degrees.

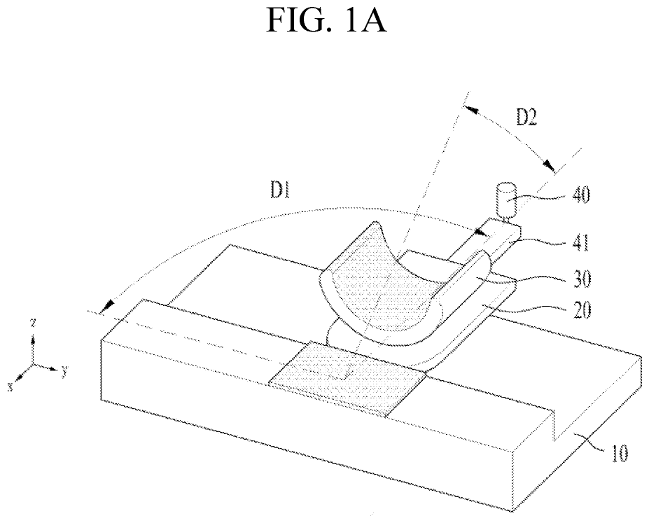

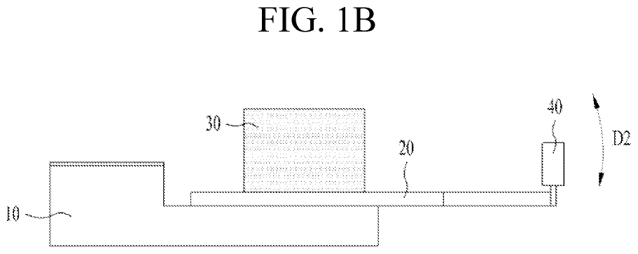

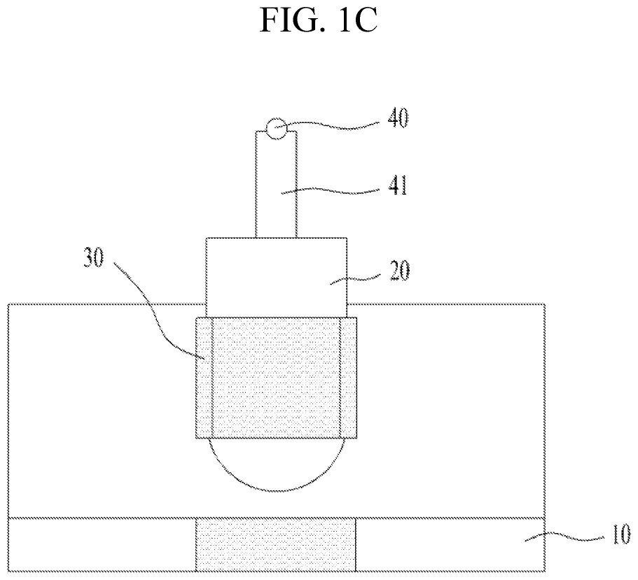

FIG. 1A is perspective, FIG. 1B is cross-sectional, and FIG. 1C is plain views illustrating a structure of an apparatus for rehabilitation according to embodiments of the present invention.

FIG. 1A is view illustrating an overall structure of the apparatus 1 for rehabilitation according to embodiments of the present invention. FIG. 1B is a longitudinal cross-sectional view of the apparatus 1 for rehabilitation when viewed from the side according to embodiments of the present invention, and FIG. 1C is a plan view of the apparatus 1 for rehabilitation when viewed from above according to embodiments of the present invention.

The apparatus 1 for rehabilitation according to embodiments may include a body 10 that is capable of being in contact with one surface of a user's body. In addition, the apparatus 1 for rehabilitation may include a support 20, which is rotatably provided on one surface of the body 10, a fixing part 30, which is provided on one surface of the support 20 to fix a user's arm, a first motor, which rotates the support 20 in a first direction by using a first axis as a rotation axis to assist abduction of the user, and a second motor, which rotates the support 20 in a second direction by using a second axis as a rotation axis to assist extention of the user.

In addition, the apparatus 1 for rehabilitation according to embodiments may include a detection part, which detects at least one or more of a first angle D1, at which the first motor is rotated from a basic state, a second angle D2, at which the second motor is rotated from the basic state, rotation resistance of the first motor, and rotation resistance of the second motor, and a control part controlling the first motor and the second motor in response to a value detected by the detection part.

Here, the basic state may be a state in which the first angle D1 has a value less than or equal to a first default value, and the second angle D2 has a value less than or equal to a second default value. Here, the first default value may be 0 degree, and if so, the user's arm will be positioned on the thigh and waist side in an attentive posture.

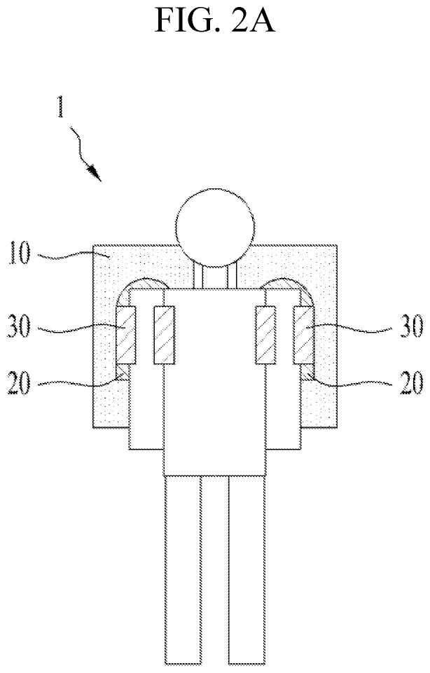

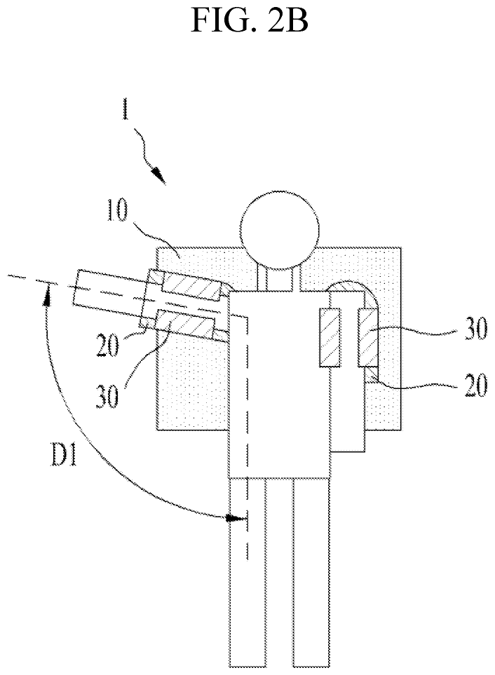

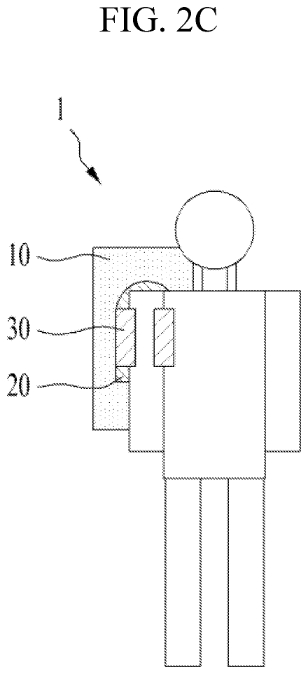

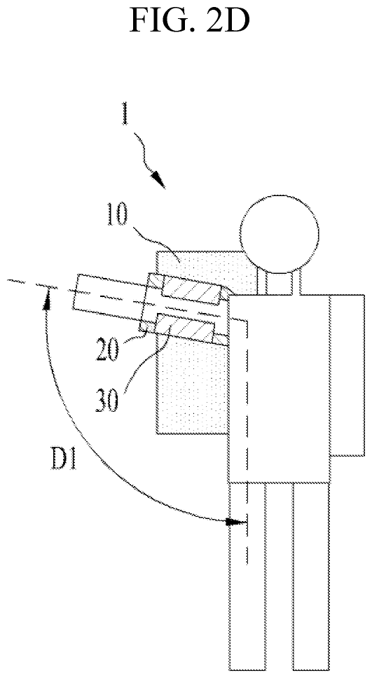

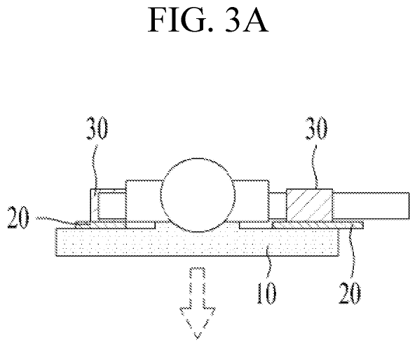

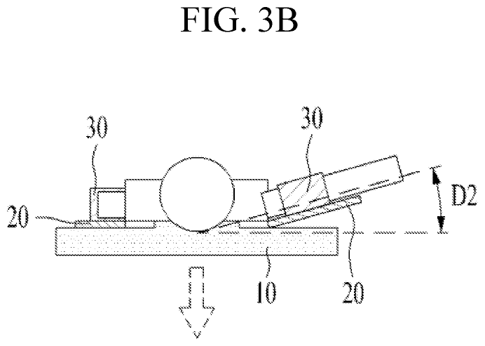

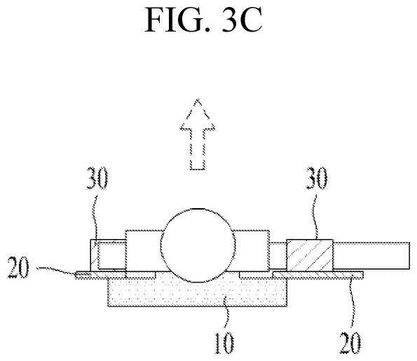

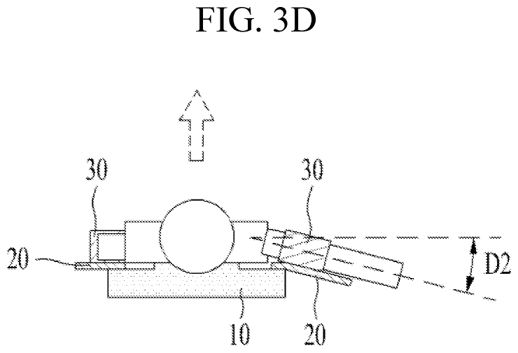

The apparatus 1 for rehabilitation according to embodiments of FIG. 1A, 1B and 1C may include only one support 20 and one fixing part 30 to stretch only one arm. However, as illustrated in FIGS. 2A, 2B, 2C, 2D and 3A, 3B, 3C, 3D, a pair of apparatuses 1 for rehabilitation is configured symmetrically so that both arms of the user are fixed to the apparatuses 1 for rehabilitation so as to be stretched, respectively.

The first motor and/or the second motor may use a servo motor, and the support 20 may be rotated by using the first axis and/or the second axis as the rotation axis through at least one or more hinge structure. In addition, when the support 20 is attached to a body 10 in the form of a ball joint, the support 20 may be rotated in a direction other than the first axis and/or the second axis.

Here, a z-axis may be the first axis that is the rotation axis, which assists the abduction of the user, and a y-axis may be the second axis that is the rotation axis, which assists the extention of the user.

Here, if the first angle D1 rotated by the first motor has a value less than or equal to the first default value, this state is referred to as a first basic state, and if the second angle D2 rotated by the second motor is less than or equal to the second default value, this state may be referred to as the second basic state. The first angle D1 in the first basic state may be about 0 degree, and the second angle D2 in the second basic state may be about 0 degree.

The apparatus 1 for rehabilitation according to embodiments may include a handle 40, which is held by the user in a state in which the arm is fixed, and a connection member 41 that connects the handle 40 to one end of the support 20. The connection member 41 according to embodiments may include a rail, a spring, or another structure. The user may adjust a distance between the handle 40 and one end of the support 20 by using the connection member 41 and allow the handle 40 to be disposed to correspond to a length of the user's arm.

A length and/or width of the body 10 may be selectively adjusted according to the direction in which the user's arm is extended.

In addition, the fixing part of the apparatus for rehabilitation according to embodiments may include at least one of a vibration pad, a heating pad, or a low-frequency pad, which surrounds the user's arm. Specifically, a shaded portion in the apparatus 1 for rehabilitation of FIG. 1A may be provided with a pad that generates vibration, heat, or a low frequency. Thus, an therapeutic effect may further increase while the user performs the rehabilitation stretching.

Hereinafter, an embodiment in which the apparatus 1 for rehabilitation according to the embodiments assists the abduction movement of the user's arm will be described with reference to FIG. 2A.

FIGS. 2A, 2B, 2C and 2D are views illustrating a state in which the apparatus 1 for rehabilitation assists the abduction movement of the user's left arm or right ram by connecting each of both the user's arms to the fixing part 30 of the apparatus 1 for rehabilitation.

FIGS. 2A and 2B illustrate an embodiment in which the user's arms are fixed at the same time by symmetrically connecting the apparatuses 1 for rehabilitation. In addition, FIGS. 2C and 2D illustrate an embodiment in which only one apparatus 1 for rehabilitation so that one apparatus assists the stretching of the user's arms. Here, the apparatus 1 for rehabilitation may have a structure capable of being comfortably mounted on either user's arm.

FIGS. 2A and 2C illustrate a posture of the user in the first basic state and the second basic state, and FIGS. 2B and 2D illustrate a state in which the apparatus 1 for rehabilitation is deviated from the first basic state to increase in the first angle D1 while assisting the abduction of the user's left or right arm.

Here, as illustrated in FIG. 2A, the apparatus 1 for rehabilitation according to embodiments may independently assist the user's left or right arm, and in the case of FIG. 2A, only the abduction of one arm is assisted, and the first motor disposed on the other arm is deviated from the first basic state in a state in which the user's left arm and/or user's right arm is placed in the first basic state and the second basic state.

Hereinafter, an embodiment in which the apparatus 1 for rehabilitation according to the embodiments assists the extention movement of the user's arm will be described with reference to FIG. 3A.

FIGS. 3A, 3B, 3C and 3D are views illustrating a state in which the apparatus 1 for rehabilitation assists the abduction movement of the user's left arm by connecting each of both the user's arms to the fixing part 30 of the apparatus 1 for rehabilitation. Here, an arrow represents the user's eyes.

FIG. 3A may be a view illustrating the state of FIG. 2B when viewed from the top, and FIG. 3B may be a view illustrating a state in which the second angle D2 increases while the apparatus 1 for rehabilitation assists the extention movement of the user's left arm in the situation of FIG. 3A. In this case, a chest portion of the user will be disposed on a portion of the body 10 of the apparatus 1 for rehabilitation.

FIG. 3C may be a view illustrating the state of FIG. 2B when viewed from the top, and FIG. 3D may be a view illustrating a state in which the second angle D2 increases while the apparatus 1 for rehabilitation assists the extention movement of the user's right arm in the situation of FIG. 3C. In this case, a back portion of the user will be disposed on the body 10 of the apparatus 1 for rehabilitation.

Here, as illustrated in FIG. 3A, the apparatus 1 for rehabilitation according to embodiments may independently assist the user's left or right arm.

In the case of FIG. 3A, the user's left arm is not in the first basic state, but is in the second basic state, and the user's right arm is in the first basic state and the second basic state. In addition, in the case of FIG. 3B, in the state in which the user's right arm is placed in the first basic state and the second basic state, only the extention of the user's left arm is assisted to be deviated from the second basic state.

In the case of FIG. 3C, the user's right arm is not in the first basic state, but is in the second basic state, and the user's left arm is in the first basic state and the second basic state. In addition, in the case of FIG. 3D, in the state in which the user's left arm is placed in the first basic state and the second basic state, only the extention of the user's right arm is assisted to be deviated from the second basic state.

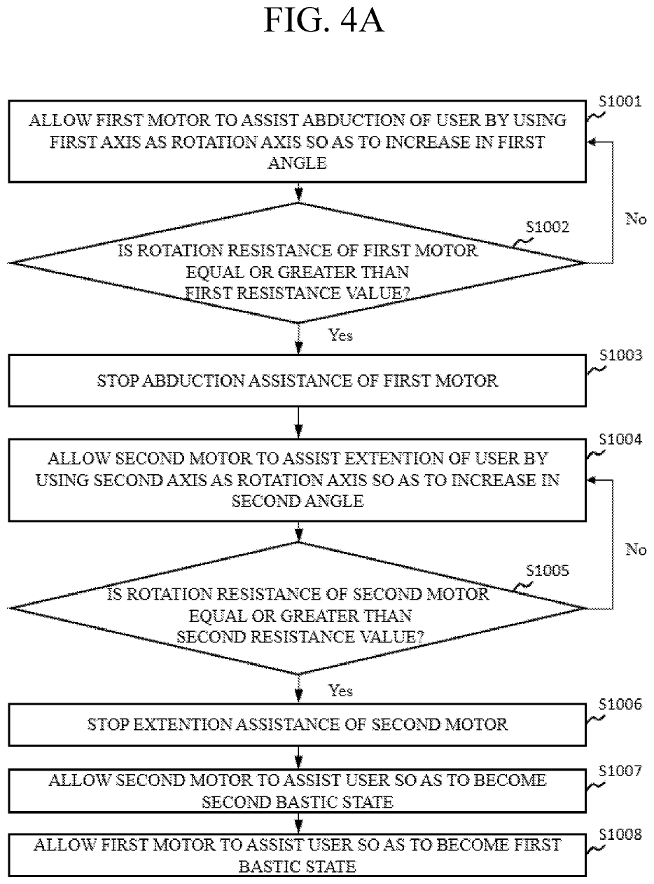

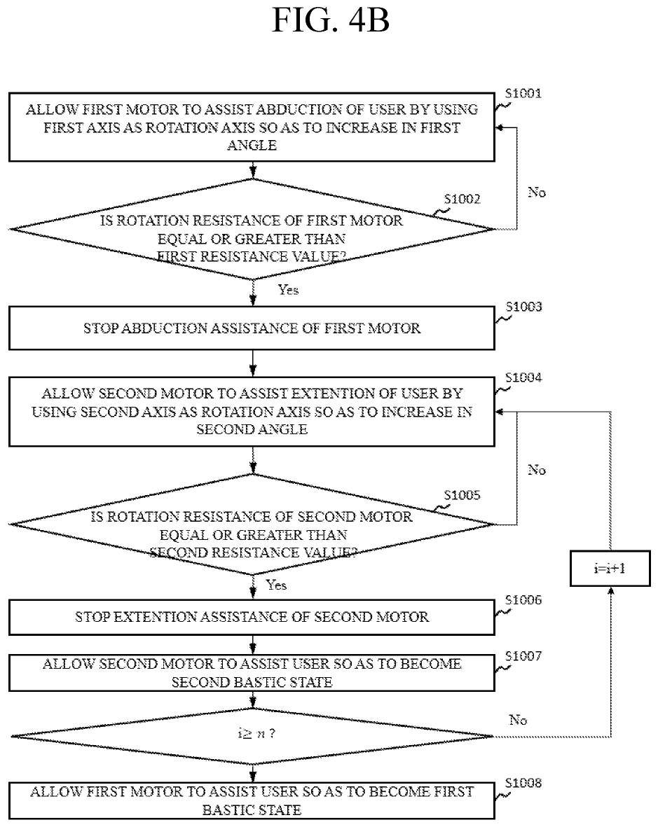

Hereinafter, a method for controlling the apparatus for rehabilitation according to embodiments will be described with reference to FIGS. 4 to 8.

FIGS. 4A and 4B are flowcharts illustrating a method for controlling the apparatus 1 for rehabilitation, which assists the user's abduction and/or extention in response to rotation resistance values of the first motor and/or the second motor, which are detected by the detection part.

Specifically, when the user's arm is abducted and/or extended by the assistance of the motor, if the abduction and/or extention is performed at a specific angle or more, a ‘range of an active motion’, which is a range in which the shoulder is movable by the user's will, exceeded. Thereafter, stretching is performed in a ‘range of a passive motion’ in which the abduction and/or extention occurs depending on power of the motor, and when the tissue in the shoulder becomes stiff to be unable to move, or a great pain range is reached, rotation resistance of the motor increases.

A control part according to embodiments may control the motor to stop the assistance of the abduction and/or extention when the detection part detects the rotation resistance of the motor, which is sufficient to cause pain to the user when the user's shoulder reaches a limit of the range of motion.

Specifically, according to the method for controlling the apparatus 1 for the rehabilitation according to the embodiment of FIG. 4A, a first motor gradually increases in a first angle D1 while assisting the user's abduction by using a first axis as a rotation axis (S1001). Here, the first angle D1 increases until rotation resistance of the first motor reaches a first resistance value, and then, when the rotation resistance of the first motor reaches the first resistance value, assistance of the abduction of the first motor may be stopped (S1002 and S1003). Thereafter, a second motor may gradually increase in a second angle D2 while assisting the extention of the user by using a second axis as a rotation axis (S1004). Here, the second angle D1 increases until the rotation resistance of the second motor reaches a second resistance value, and then, when the rotation resistance of the second motor reaches the second resistance value, assistance of the extention of the second motor may be stopped (S1005 and S1006). Thereafter, the second motor may assist the user until a second basic state (S1007), and the first motor may assist the user until the first basic state (S1008).

In addition, according to the method for controlling the apparatus 1 for rehabilitation according to the embodiment of FIG. 4B, based on the embodiment of FIG. 4A, operations S1004 to S1007 are repeated until the preset number n of times of stretching is reached. Here, after setting a value of the number i of times of extention assistance to 0 in a stage of starting the extention assistance, the value of the number i may increase by one whenever the extention assistance is performed once. Also, when the preset number n of times of stretching is reached, it is possible to assist the user so that the first motor becomes the first basic state (S1008).

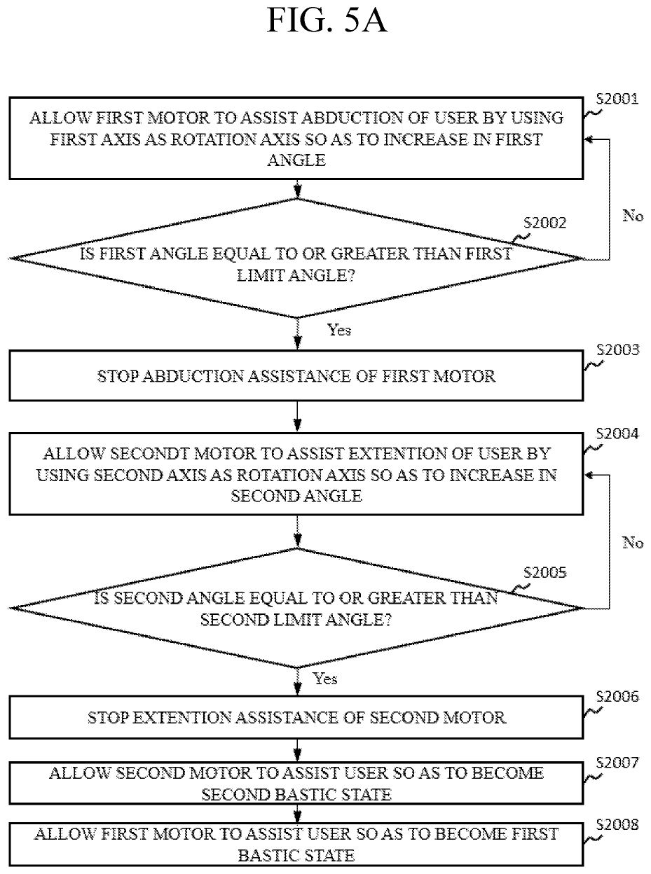

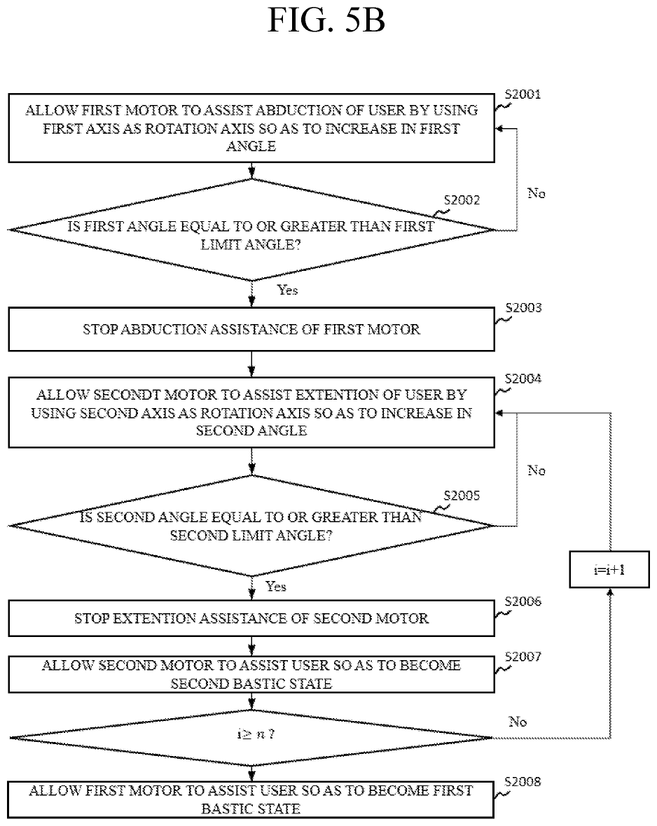

FIGS. 5A and 5B are flowcharts illustrating a method for controlling the apparatus 1 for rehabilitation, which assists the user's abduction and/or extention in response to the first angle D1 of the first motor and/or the second angle D2 of the second motor, which are detected by the detection part.

The control part according to embodiments may control the motor to stop the assistance of the abduction and/or extention when the detection part detects the rotation angle of the motor, which is sufficient to cause pain when the user's shoulder reaches the limit of the range of motion.

Specifically, according to the method for controlling the apparatus 1 for the rehabilitation according to the embodiments of FIG. 5A, the first motor gradually increases in the first angle D1 while assisting the user's abduction by using the first axis as the rotation axis (S2001). Here, the first angle D1 increases until the angle of the motor reaches a first limit angle, and then, when the first angle D1 reaches the first limit angle, the assistance of the abduction of the first motor may be stopped (S2002 and S2003). Thereafter, the second motor may gradually increase in the second angle D2 while assisting the extention of the user by using the second axis as the rotation axis (S2004). Here, the second angle D2 increases until the angle of the motor reaches a second limit angle, and then, when the second angle D2 reaches the second limit angle, the assistance of the extention of the second motor may be stopped (S2005 and S2006). Thereafter, the second motor may assist the user until a second basic state (S2007), and the first motor may assist the user until the first basic state (S2008).

In addition, according to the method for controlling the apparatus 1 for rehabilitation according to the embodiment of FIG. 5B, based on the embodiment of FIG. 5A, operations S2004 to S2007 are repeated until the preset number n of times of stretching is reached. Here, after setting a value of the number i of times of extention assistance to 0 in a stage of starting the extention assistance, the value of the number i may increase by one whenever the extention assistance is performed once. Also, when the preset number n of times of stretching is reached, it is possible to assist the user so that the first motor becomes the first basic state (S2008).

The first resistance value, the second resistance value, the first limit angle, and/or the second limit angle, which are illustrated in the embodiments of FIGS. 4A to 5B, may be preset values and also may be values capable of being arbitrarily set by the user.

The user's stretching assistance according to the embodiments of FIGS. 4A to 5B may be repeated at least once to help the user's rehabilitation. The number of times of repetitions is preferably between about 10 times to about 20 times.

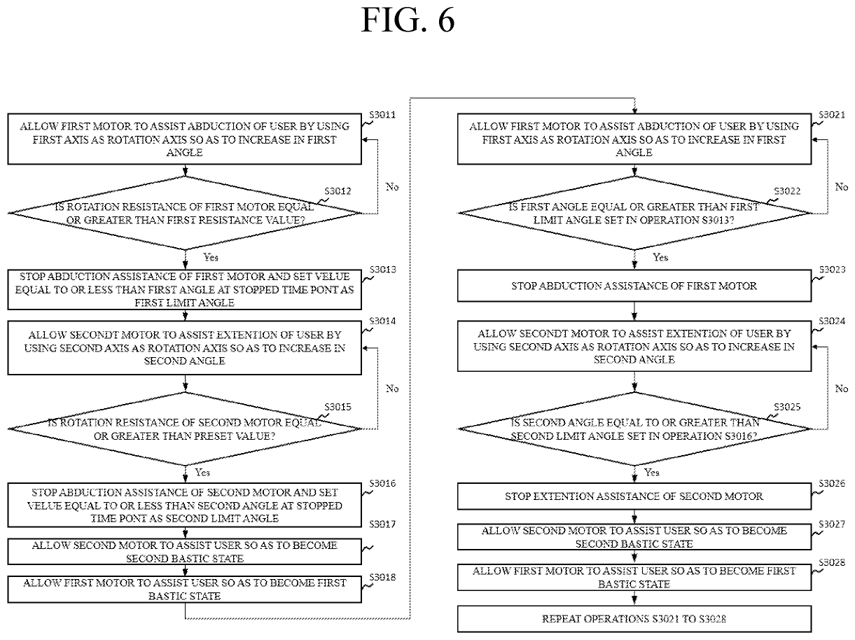

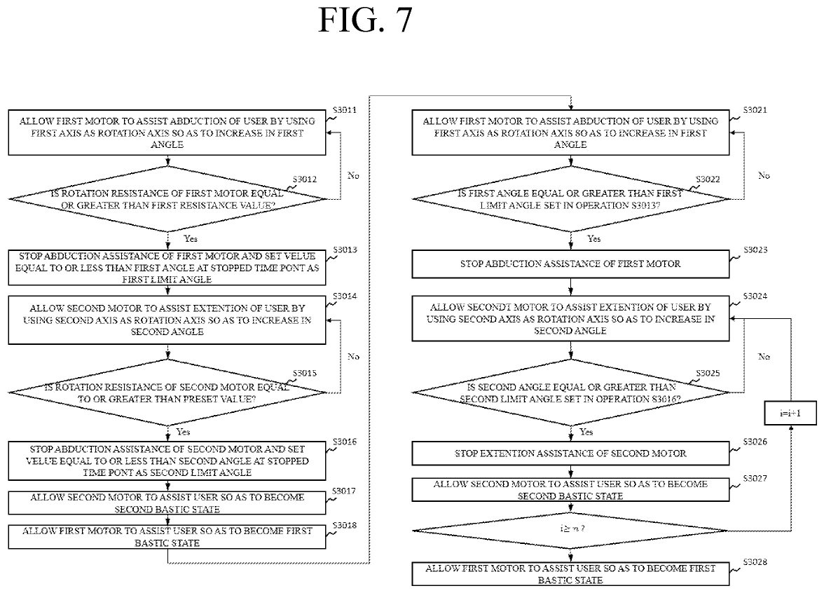

Hereinafter, with reference to FIGS. 6 and 7, the method for controlling the apparatus 1 for rehabilitation, which assists the user's stretching by detecting the rotation resistance to the extent that the user feels pain to set the value less than the rotation resistance as the limit angle will be described.

According to the embodiments of FIGS. 4 and/or 5, when an auxiliary range of the abduction and/or extention is determined based on the rotation angle or rotation resistance of the motor, the user's pain may be great. Therefore, the rotation angle of the motor, which is less than the range in which the user is likely to feel great pain may be set as the limit angle, and thus, the stretching may be repeated based on the set limit angle.

Specifically, according to the method for controlling the apparatus 1 for the rehabilitation according to the embodiments of FIG. 6, the first motor gradually increases in the first angle D1 while assisting the user's abduction by using the first axis as the rotation axis (S3001). Here, the first angle D1 increases until rotation resistance of the first motor reaches a first resistance value, and then, when the rotation resistance of the first motor reaches the first resistance value, assistance of the abduction of the first motor may be stopped, and then, a value less than or equal to the first angle D1 at the stopped time point may be set as the first limit angle (S3012 and S3013). Thereafter, the second motor may gradually increase in the second angle D2 while assisting the extention of the user by using the second axis as the rotation axis (S3014). Here, the second angle D1 increases until the rotation resistance of the second motor reaches a second resistance value, and then, when the rotation resistance of the second motor reaches the second resistance value, assistance of the extention of the second motor may be stopped, and then, a value less than or equal to the second angle D2 at the stopped time point may be set as the second limit angle (S3015 and S3016). Thereafter, the second motor may assist the user until a second basic state (S3017), and the first motor may assist the user until the first basic state (S3018).

After the limit angle is set, the first motor may gradually increase in the first angle D1 while assisting the abduction of the user by using the first axis as the rotation axis (S3021). Here, while the first angle D1 increases, when the first angle D1 reaches the first limit angle set in operation S3013, the abduction assistance of the first motor may be stopped (S3022 and S3023). Thereafter, the second motor may gradually increase in the second angle D2 while assisting the extention of the user by using the second axis as the rotation axis (S3024). Here, the second angle D2 increases until the angle of the motor reaches a second limit angle set in operation S3016, and then, when the second angle D2 reaches the second limit angle, the assistance of the extention of the second motor may be stopped (S3025 and S3026). Thereafter, the second motor may assist the user until a second basic state (S3027), and the first motor may assist the user until the first basic state (S3028). Thereafter, the operations S3021 to S3028 may be repeated as much as necessary for the user's stretching.

In addition, according to the method for controlling the apparatus 1 for rehabilitation according to the embodiment of FIG. 7, based on the embodiment of FIG. 6, the operations S3024 to S3027 are repeated until the preset number n of times of stretching is reached. Here, after setting a value of the number i of times of extention assistance to 0 in a stage of starting the extention assistance, the value of the number i may increase by one whenever the extention assistance is performed once. Also, when the preset number n of times of stretching is reached, it is possible to assist the user so that the first motor becomes the first basic state (S3028).

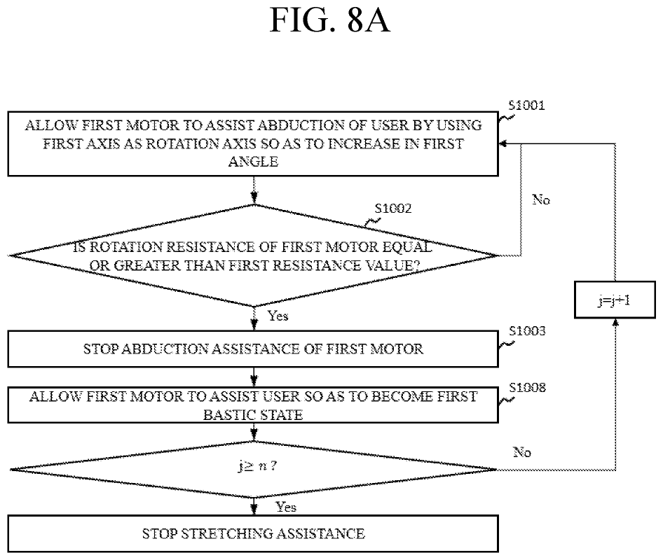

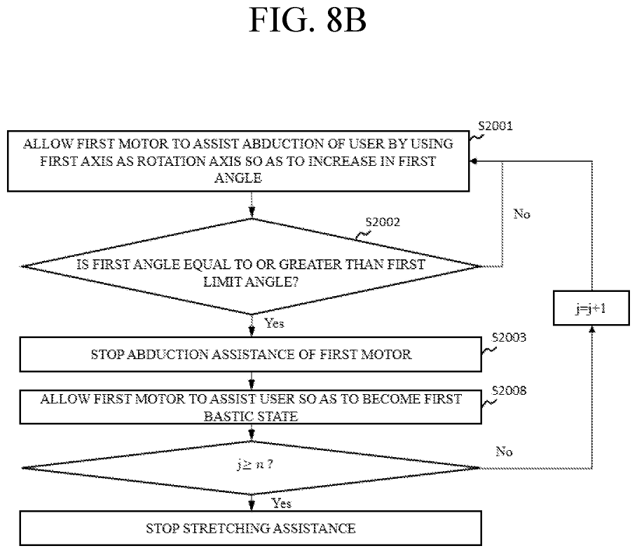

Additionally, the embodiment of FIGS. 8A and 8B illustrate a method for controlling the apparatus 1 for rehabilitation, which repeats only the assistance of the abduction without the extention assistance.

Specifically, according to the method for controlling the apparatus 1 for the rehabilitation according to the embodiment of FIG. 8A, a first motor gradually increases in a first angle D1 while assisting the user's abduction by using a first axis as a rotation axis (S1001). Here, the first angle D1 increases until rotation resistance of the first motor reaches a first resistance value, and then, when the rotation resistance of the first motor reaches the first resistance value, assistance of the abduction of the first motor may be stopped (S1002 and S1003). Thereafter, the apparatus 1 for rehabilitation may assist the user until the first motor is in the first basic state (S1008). In addition, the operations S1001, S1002, S1003, and S1008 may be repeated up to the preset number n of times of stretching. Here, after setting a value of the number j of times of abduction assistance to 0 in a stage of starting the abduction assistance, the value of the number j may increase by one whenever the abduction assistance is performed once. Also, when the preset number n of times of stretching is reached, the apparatus 1 for rehabilitation may be controlled to stop the stretching assistance.

In addition, according to the method for controlling the apparatus 1 for the rehabilitation according to the embodiment of FIG. 8B, the first motor gradually increases in the first angle D1 while assisting the user's abduction by using the first axis as the rotation axis (S2001). Here, the first angle D1 increases until the angle of the motor reaches a first limit angle, and then, when the first angle D1 reaches the first limit angle, the assistance of the abduction of the first motor may be stopped (S2002 and S2003). Thereafter, the apparatus 1 for rehabilitation may assist the user until the first motor is in the first basic state (S2008). In addition, the operations S2001, S2002, S2003, and S2008 may be repeated up to the preset number n of times of stretching. Here, after setting a value of the number j of times of abduction assistance to 0 in a stage of starting the abduction assistance, the value of the number j may increase by one whenever the abduction assistance is performed once. Also, when the preset number n of times of stretching is reached, the apparatus 1 for rehabilitation may be controlled to stop the stretching assistance.

In addition, the apparatus 1 for rehabilitation according to the embodiments may further include a remote controller for controlling the control part.

When the remote controller according to the embodiments is used, the user may more precisely control the abduction assistance and/or extention assistance of the apparatus 1 for rehabilitation. In addition, any one of the low-frequency pad, the vibration pad, and the heating pad may be controlled.

The frozen shoulder patients may be improved in efficiency of the rehabilitation through the present invention. According to the embodiments of the present invention, the motor may assist the abduction of the user's arm up to the limit value of the tolerable pain of the user. Thereafter, in the state in which the arm is abducted to the limit value, the motor may assist the extention of the user's arm up to the limit value of the tolerable pain of the user.

In addition, the limit value in range of the user's motion may be stored to control the apparatus for the rehabilitation so that the assistance of the abduction and/or extention is automatically stopped in the range in which the user's pain is not severe when stretching afterward.

According to the present invention, the apparatus may be installed horizontally or vertically on the bed or flat ground, and the user's arm may be minimized in influence from the gravity so as to be assisted in abduction. The woman and/or elderly person who lacks the muscle strength to the extent that the active exercise treatment is impossible may be stretched in abduction and/or extention by utilizing the present invention.

As described above, the present invention is not limited to the above-described embodiments. It is to be understood that the invention is intended to cover various modifications and equivalent arrangements included within the spirit and scope of the appended claims.

What is claimed is:

1. An apparatus for rehabilitation, comprising:
a body;
a support that is rotatably provided on one surface of a body;
a fixing part that is provided on one surface of the support to fix a user's arm;
a first motor that rotates the support in a first direction by using a first axis as a rotation axis to assist abduction of the user;
a second motor that rotates the support in a second direction by using a second axis as a rotation axis to assist extention of the user;
a detection part that detects at least one or more of a first angle, at which the first motor is rotated from a basic state, a second angle, at which the second motor is rotated from the basic state, rotation resistance of the first motor, and rotation resistance of the second motor; and
a control part that controls the first motor and the second motor in response to a value detected by the detection part.

2. The apparatus of claim 1, wherein, in the first basic state, the first angle has a value less than or equal to a first default value, and
in the second basic state, the second angle has a value less than or equal to a second default value.

3. The apparatus of claim 1, wherein, when the rotation resistance of the first motor is equal to or greater than a first resistance value, the control part controls the first motor to stop the rotation for the abduction assistance, and
when the rotation resistance of the second motor is equal to or greater than a second resistance value, the control part controls the second motor to stop the rotation for the extention assistance.

4. The apparatus of claim 1, wherein, when the first angle is equal to or greater than a first limit angle, the control part controls the first motor to stop the rotation for the abduction assistance, and
when the second angle is equal to or greater than a second limit angle, the control part controls the second motor to stop the rotation for the extention assistance.

5. The apparatus of claim 1, further comprising:
a handle that is held by the user in a state in which the arm is fixed; and
a connection member that connects the handle to one end of the support.

6. The apparatus of claim 5, wherein the connection member comprises a rail or a spring, and
a distance between the handle and one end of the support is adjustable.

7. The apparatus of claim 1, wherein the fixing part further comprises a vibration pad that surrounds the user's arm.

8. The apparatus of claim 1, wherein the fixing part further comprises a heating pad that surrounds the user's arm.

9. A method for controlling an apparatus for rehabilitation, which is used in a state in which a user's arm is fixed to a support, the method comprising:
a first process of assisting abduction of a user while increasing in a first angle at which a first motor having a first axis as a rotation axis is rotated;
a second process of stopping the assistance of the abduction of the user when a measured value with respect to the first motor is greater than or equal to a first reference value;
a third process of assisting extension of the user while increasing a second angle at which a second motor having a second axis as a rotation axis is rotated; and
a fourth process of stopping the assistance of the extention of the user when a measured value with respect to the second motor is greater than or equal to a second reference value.

10. The method of claim 9, wherein the first reference value is a first resistance value that is rotation resistance of the first motor, and
the second reference value is a second resistance value that is rotation resistance of the second motor.

11. The method of claim 9, wherein the first reference value is a first limit angle that is a value to which the first angle increases maximally, and
the second reference value is a second limit angle that is a value to which the second angle increases maximally.

12. The method of claim 9, further comprising, after the fourth process, a fifth process of assisting the user so that the second motor becomes a second basic state; and
a sixth process of assisting the user so that the first motor becomes a first basic state.

13. The method of claim 12, wherein, in the first basic state, the first angle has a value less than or equal to a first default value, and
in the second basic state, the second angle has a value less than or equal to a second default value.

14. The apparatus of claim 1, wherein the fixing part further comprises a low-frequency pad that surrounds the user's arm.
